(19) United States
(12) Patent Application Publication
(10) Pub. No.: US 2007/0152732 A1
(43) Pub. Date: Jul. 5, 2007

(54) Method and apparatus to detect electrical overstress of a device

(76) Inventor: Walter E. Solano, San Jose (CR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/322,826

(22) Filed: Dec. 30, 2005

(51) Int. Cl. H01H 37/76

(52) U.S. Cl. 327/525

(57) ABSTRACT

According to embodiments of the present invention, an integrated circuit such as a processor includes a power plane to supply a predetermined operating voltage in the integrated circuit less than or equal to a reference voltage. A comparator compares the voltage supplied by the power plane to the reference voltage and outputs a logic high if the voltage supplied by the power plane is greater than the reference voltage. If the output of the comparator is logic high, then a transistor turns on and a fuse burns open.

### BACKGROUND

1. Field

Embodiments of the present invention relate to integrated circuits and, in particular, to testing of integrated circuits.

2. Discussion of Related Art

In general, integrated circuit (IC) devices can be memory devices such as read-only memory (ROM) and random access memory (RAM), instruction processing devices such as processors, microprocessors, and multiprocessors, or other device microcircuit formed on a substrate. When devices are sold to original equipment manufacturers (OEMs), for example, the products are usually accompanied by the device specifications. The specifications typically include the acceptable operating conditions, connection recommendations, direct current (DC) specifications, and alternating current (AC) specifications. The device is commonly warranted to perform according to the specifications.

If a device fails during the manufacturing process or once it has been shipped to the OEM, the device manufacturer may perform certain tests on the device in an attempt to detect a reason for the failure. Current failure analysis techniques have limitations, however.

### BRIEF DESCRIPTION OF THE DRAWINGS

In the drawings, like reference numbers generally indicate identical, functionally similar, and/or structurally equivalent elements. The drawing in which an element first appears is indicated by the leftmost digit(s) in the reference number, in which:

FIG. 1 is a simplified block diagram of a computer system according to an embodiment of the present invention;

FIG. 2 is a diagram illustrating the failure analysis module depicted in FIG. 1 according to an embodiment of the present invention;

FIG. 3 is a flowchart illustrating a method for operating the computer system depicted in FIG. 1 according to an embodiment of the present invention;

FIG. 4 is a flowchart illustrating a method for operating the computer system depicted in FIG. 1 according to an alternative embodiment of the present invention; and

FIG. 5 is a diagram illustrating a failure analysis module according to an alternative embodiment of the present invention.

### DETAILED DESCRIPTION OF EMBODIMENTS

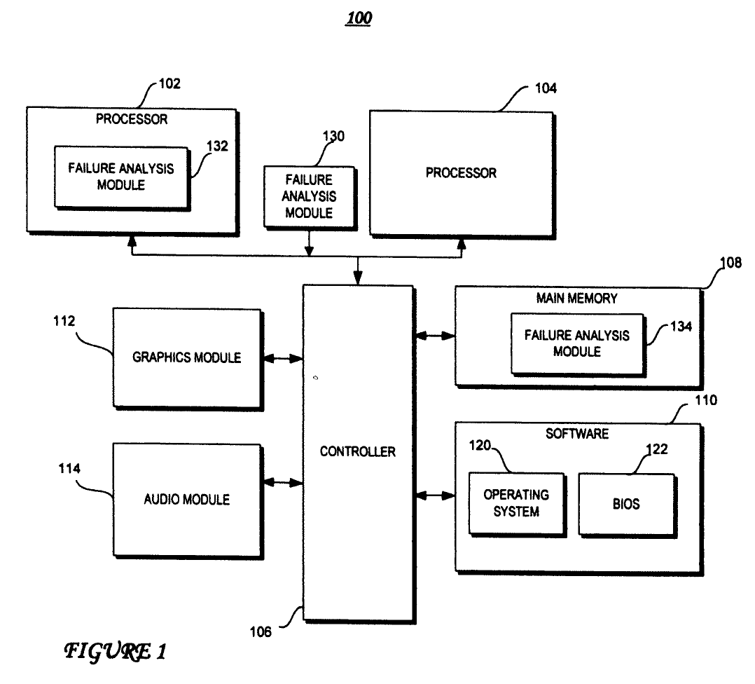

FIG. 1 is a simplified block diagram of a computer system 100 according to an embodiment of the present invention. The computer system 100 in the illustrated embodiment includes two processors 102 and 104 coupled to a controller 106. Main memory 108, software 110, graphics module 113 and audio module 114 also are coupled to the controller 106. The software 110 in the illustrated embodiment includes an operating system 120 and a basic input/output system (BIOS) 122.

The computer system 100 may be part of a server, such as a processor-based server, for example. Alternatively, the computer system 100 may be part of a chipset, such as a desktop, laptop, or server chipset.

Although illustrated as processors, the processor 102 and/or the processor 104 may be any suitable integrated circuit such as microprocessors, multiprocessors, microcomputers, and/or central processing units. The processor 102 and/or 104 may perform their conventional functions of executing programming instructions, including implementing the teachings of the embodiments of the present invention.

In some embodiments, the controller 106 may manage main memory 108, the graphics module 112, and the audio module 114 and may perform conventional functions of controlling and monitoring the status of memory data lines, error checking, etc. In other embodiments, the controller 106 controls other peripherals accessing the processors 102 and/or 104.

Main memory 108 in some embodiments performs its conventional functions of storing data (pixels, frames, audio, video, etc.) and software (control logic, instructions, code, computer programs, etc.) for access by other computer system 100 components. In general, main memory 108 includes several data lines corresponding to several addressable storage locations. Suitable memory can be a random access memory (RAM).

Software 110, in general, may be control logic, instructions, commands, code, computer programs, etc., executed by the computer system 100 to perform functions described herein. Software 110 may implement hyper-threading technology.

For some embodiments, the graphics module 112 may be integrated into the chipset that supports the processors 102 and 104. In alternative embodiments, the graphics module 112 may be a discrete graphics card that includes a separate processor (not shown) with separate memory (not shown).

For some embodiments, the audio module 114 also may be a hardware buffer.

The operating system 120 may perform its conventional functions of managing the allocation and de-allocation of resources within the computer system 100 during execution of programs. The operating system 120 may be stored in a ROM device.

The basic input/output system (BIOS) 122 may be a low-level interface set of instructions between application software and hardware. The BIOS 122 typically includes a set of functions that are performed when the software 110 invokes a specific routine. The BIOS 122 may be stored in a read only memory (ROM) device.

For some embodiments, the computer system 100 may include one or more failure analysis modules that may be implemented to determine whether a part of the computer system 100 experienced electrical overstress or was subject to an abnormal parameter such as voltage, for example. In the illustrated embodiment, the computer system 100 includes a failure analysis module 130 to determine whether a part of the computer system 100 overall experienced electronic overstress or was subject to an abnormal parameter, the processor 102 includes a failure analysis module 132 to determine whether a part of the processor 102 experienced electronic overstress or was subject to an abnormal parameter, and main memory 108 includes a failure analysis module 134 to determine whether a part of main memory 108 experienced electronic overstress or was subject to an abnormal parameter.

The computer system 100, including processors 102 and 104, as well as the parts of the chipset (e.g., controller 106, main memory 108, etc.) may individually or taken together be considered an integrated circuit.

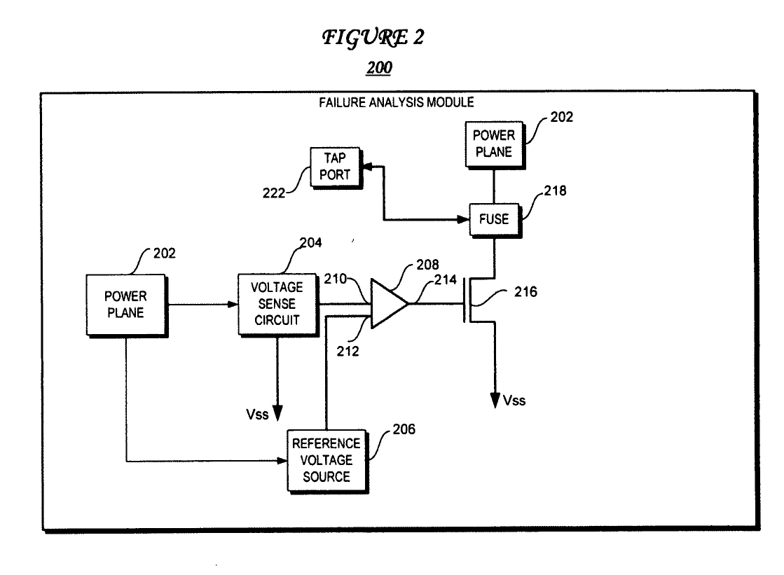

FIG. 2 is a diagram illustrating a failure analysis module 200 according to an embodiment of the present invention in which an integrated circuit or component is tested prior to and after shipment to an original equipment manufacturer (OEM), for example. The failure analysis module 200 may be part of any one of the failure analysis modules 130, 132, and/or 134, or other failure analysis module implemented according to embodiments of the present invention.

In the illustrated embodiment, failure analysis module 200 includes a power plane 202 coupled to a voltage sense circuit 204 and to a reference voltage source 206. An output of the voltage sense circuit 204 is coupled to a comparator 208 via an input 210. An output of the reference voltage source 206 is coupled to the comparator 208 via an input 212. An output 214 of the comparator 208 is coupled to a gate of a transistor 216. A drain of the transistor 216 is coupled to one end of at least one fuse 218. The other end of the fuse 218 is coupled to the power plane 202. The voltage sense circuit 204 and the source of the transistor 216 are coupled to a ground plane Vss. A test access port (TAP) 222 is coupled to the fuse 218.

For some embodiments, the power plane 202 may be any power plane within the computer system 100 that is suitable for monitoring the voltage on the power plane. For example, the power plane 202 may be the power plane that supplies the operating voltage to the chipset in the computer system 100. Alternatively, the power plane 202 may be the power plane that supplies the operating voltage to the processors 102 and/or 104, or to main memory. Alternatively still, the power plane 202 may be the power plane that supplies the operating voltage to the graphics module 112 and/or the audio module 114.

The voltage sense circuit 204 may be any suitable circuit that is capable of sensing voltage output from the power plane 202. The voltage sense circuit 204 may be an off-the-shelf component or a proprietary circuit design that is capable of sensing voltage output from the power plane 202.

The reference voltage source 206 may be any suitable source of a reference voltage. For example, the reference voltage source 206 may be a separate power plane, an off-the-shelf component, or a proprietary circuit design that is capable of providing a regulated voltage to the input 212 of the comparator 208.

The comparator 208 may be any suitable off-the-shelf component, such as an operational amplifier, for example, or a proprietary circuit design that is capable of comparing the voltage on the input 210 to the reference voltage on the input 212 and switching the output 214 from one value to another value to indicate which is larger. In one embodiment, the comparator 208 may switch values when the voltage from the power plane 202 via the voltage sense circuit 204 is larger than the reference voltage.

The transistor 216 may be any suitable transistor that turns on when the voltage on its gate is greater than the threshold voltage of the transistor 216. In some embodiments, the transistor 216 is a metal oxide semiconductor field effect transistor (MOSFET). In other embodiments, the transistor 216 may be a high current transistor.

The fuse 216 may be any suitable fuse that is burnt or blown open when the current through the fuse 216 exceeds a predetermined current. Alternatively, the fuse 216 may be any suitable antifuse that is burnt or blown short when the current through the fuse 216 exceeds a predetermined current. In one embodiment, the fuse 216 may be a polysilicon fuse. Also, although illustrated as a single fuse, the fuse 216 may be several fuses. The TAP port 222 may be used to read the values store in the one or more fuses 216. A Joint Test Action Group (JTAG) tester (not shown) or other suitable testing circuitry may be coupled to the TAP port 222 to read the values store in the one or more fuses 216. The testing circuitry may read the fuses 216 to determine whether they are blown, partially blown, or not blown.

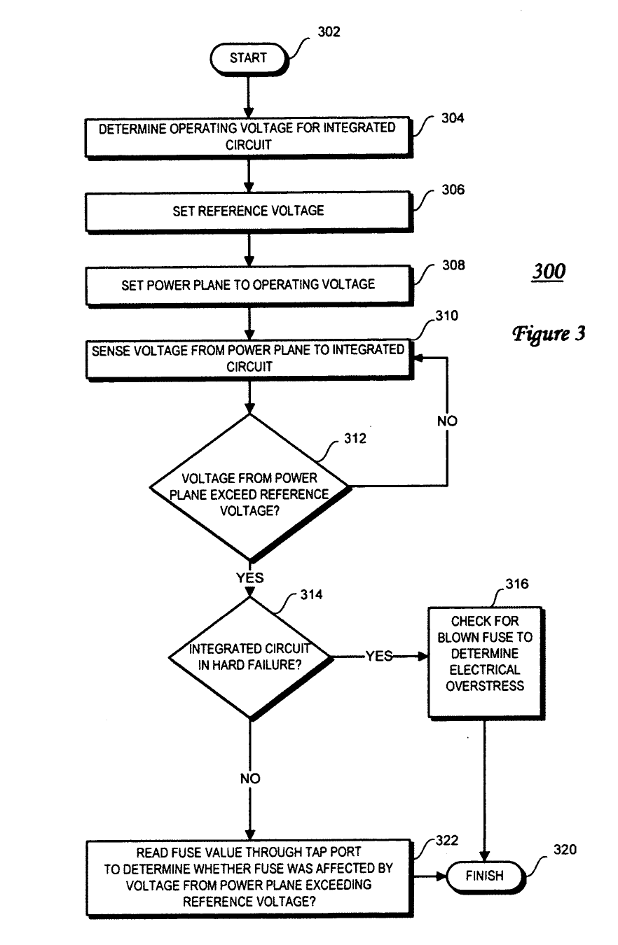

FIG. 3 is a flowchart illustrating a process 300 for operating the computer system 100 according to an embodiment of the present invention in which the failure analysis module 200 may be used to determine why all or part of the computer system 100 has failed, during testing prior to prior to shipment to an original equipment manufacturer (OEM), for example. The process 300 begins with a block 302, where control passes to a block 304.

In the block 304, an operating voltage for at least one of the integrated circuits may be determined. For some embodiments, the block 304 may determine the operating voltage for the computer system 100. For other embodiments, the block 304 may determine the operating voltage for main memory 108. In still other embodiments, the block 304 may determine the operating voltage for the processor 102.

In a block 306, the reference voltage may be set. For some embodiments, the reference voltage source 206 is set to be greater than the operating voltage determined in the block 304 and the reference voltage may be applied to the input 212 of the comparator 208. The output 214 of the comparator 208 may be a logical low at this point. If the output 214 of the comparator 208 is a logical low, then the transistor 216 is turned off. If the transistor 216 is turned off, then there is substantially no current flowing in the transistor 216. If substantially no current is flowing in the transistor 216, then the fuse 218 is intact.

In one embodiment, the reference voltage from the reference voltage source 206 may be set to a burn-in voltage of the particular integrated circuit. Burn-in is the process by which the component manufacturer may screen out a marginal device by exposing the component to elevated temperatures and voltage stress. Thus, in one embodiment, the reference voltage from the reference voltage source 206 may be set at the burn-in voltage for the computer system 100, the processor 102, the controller 106, main memory 108, etc.

For some embodiments, the voltage sense circuit 204 may reduce the voltage output from the power plane 202. In these embodiments, the reference voltage from the reference voltage source 206 may be reduced accordingly.

In a block 308, the power plane 202 is set to supply the operating voltage of the integrated circuit. For example, the power plane 202 may be set the operating voltage of the processor 102, main memory 108, the chipset, or computer system 100, for example.

In a bock 310, the voltage from the power plane 202 applied to the particular integrated circuit is sensed to the voltage sense circuit 204, which senses the voltage and couples the sensed voltage to the input 210 of the comparator 208.

In a block 312, it is determined whether the voltage from the power plane 202 exceeded the reference voltage from the reference voltage source 206. If the voltage from the power plane 202 did not exceed the reference voltage from the reference voltage source 206, then the difference in voltage on the inputs 210 and 212 of the comparator 208 do not cause the comparator 208 to trip and the output 214 of the comparator 208 remains the same, which is a logical low. The process 300 returns to the block 310 and voltage continues to be applied to the particular integrated circuit.

If in a block 312, the voltage from the power plane 202 exceeds the reference voltage from the reference voltage source 206, then the difference in voltage on the inputs 210 and 212 of the comparator 208 may cause the comparator 208 to trip and the output 214 of the comparator 208 may switch to a logical high. If the output 214 of the comparator 208 is a logical high, then the transistor 216 is turned on. If the transistor 216 is turned on, then there is current is flowing in the transistor 216. If there is current is flowing in the transistor 216, then the fuse 218 may be blown.

In a block 314 it is determined whether the integrated circuit is in hard failure as a result of the fuse 218 blowing. In a hard failure, the integrated circuit may not be functional at all. A soft failure may be where the integrated circuit's performance is marginally functional.

If the integrated circuit is in hard failure, then in a block 316 the fuse 216 may be physically inspected to determine whether it is blown. A blown fuse 216 is an indication that the cause for the hard failure of the integrated circuit was electrical overstress, such as applying a voltage in excess of the recommended operating voltage. A fuse 216 that is not blown is an indication that the cause for the hard failure of the integrated circuit was not necessarily electrical overstress, such as applying a voltage in excess of the recommended operating voltage, but some other reason. The process 300 then finishes in a block 320.

If the integrated circuit is not in hard failure, then in a block 322 the value in the fuse 218 is read using the TAP port 222 to determine whether the fuse 218 was affected by the voltage from the power plane 202 exceeding the reference voltage from the reference voltage source 206. For some embodiments, one value in the fuse 216 may be an indication that the cause for the soft failure of the integrated circuit was electrical overstress, such as applying a voltage in excess of the recommended operating voltage. For other embodiments, another value in the fuse 216 is an indication that the cause for the soft failure of the integrated circuit was not necessarily electrical overstress, such as applying a voltage in excess of the recommended operating voltage, but some other reason.

The process 300 finishes in a block 320. It can then be determined whether the particular circuit may need to be redesigned to reduce the risk of electrical overstress and resulting hard and/or soft failures prior to shipment of OEMs.

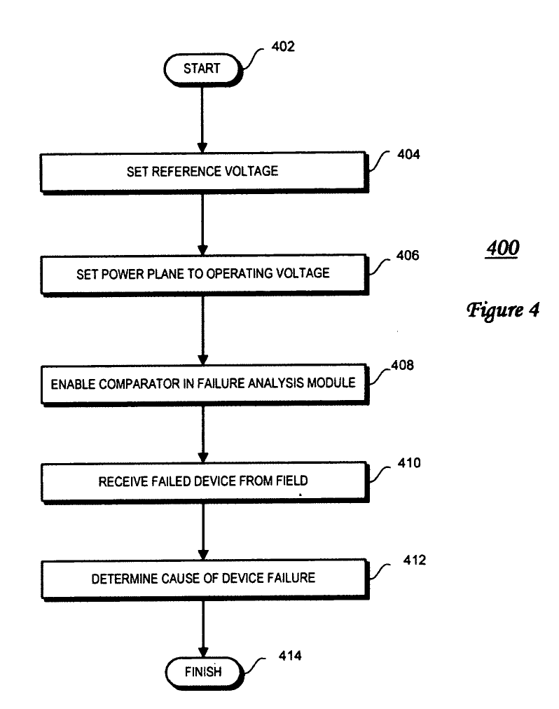

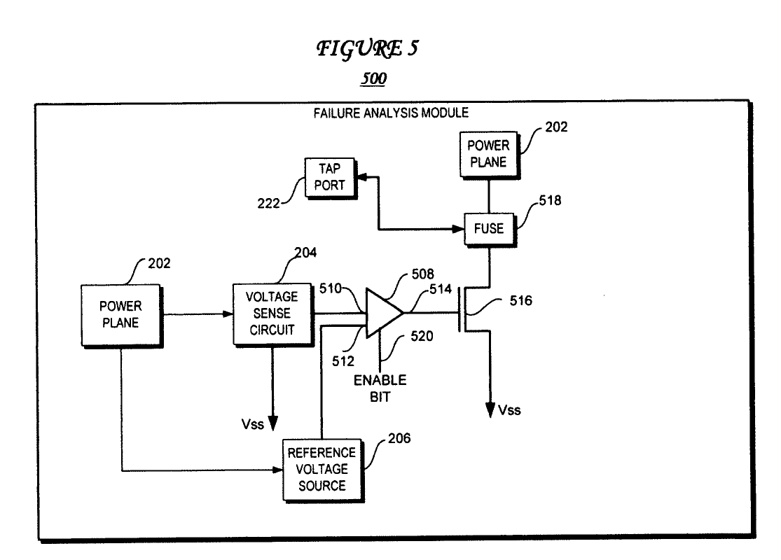

FIG. 4 is a flowchart illustrating a process 400 for operating the computer system 100 according to an embodiment of the present invention in which the failure analysis module 200 and a failure analysis module 500 shown in FIG. 5 may be used to determine why all or part of the computer system 100 has failed, after the computer system 100 has been shipped to an original equipment manufacturer (OEM), for example. In the illustrated embodiment, the failure analysis module 500 is shown to be substantially the same as the failure analysis module 200 in that the power plane 202 coupled to the voltage sense circuit 204 and to the reference voltage source 206. An output of the voltage sense circuit 204 is coupled to a second comparator 508 via an input 510.

An output of the reference voltage source 206 is coupled to the comparator 508 via an input 512. An output 514 of the comparator 508 is coupled to a gate of a second transistor 516. A drain of the transistor 516 is coupled to one end of a second fuse 518, which may be one or more fuses. The other end of the fuse 518 is coupled to the power plane 202. The voltage sense circuit 204 and the source of the transistor 516 are coupled to a ground plane Vss. The comparator 508 includes an input 520 to receive an enable bit. The test access port (TAP) 222 is coupled to the fuse 518.

The process 400 begins with a block 402, where control passes to a block 404.

In a block 404, the reference voltage is set.

In a block 406, the power plane 202 is set to the operating voltage of the computer system 100.

In a block 408, the comparator 508 is enabled by activating the enable bit on the input pin 520. A second set of fuses, for example, may be used to activate the enable bit. For some embodiments, the computer system 100 or individual components implemented according to embodiments of the present invention are then shipped to OEMs or other users with both the failure analysis module 200 and the failure analysis module 500 being activated.

In a block 410, the computer system 100 or individual components implemented according to embodiments of the present invention are received from OEMs or other users as having failed.

In a block 412, the cause of the failure may be determined. For some embodiments, all or part of the process 300 is implements in order to determine the cause of the failure of the returned computer system 100 or individual components implemented according to embodiments of the present invention.

In a block 414, the process 400 finishes.

The operations of the processes 300 and 400 have been described as multiple discrete blocks performed in turn in a manner that may be most helpful in understanding embodiments of the invention. However, the order in which they are described should not be construed to imply that these operations are necessarily order dependent or that the operations be performed in the order in which the blocks are presented. Of course, the processes 300 and 400 are example methods and other methods may be used to implement embodiments of the present invention.

Embodiments of the present invention may be implemented using hardware, software, or a combination thereof. In implementations using software, the software or machine-readable data may be stored on a machine-accessible medium. The machine-readable data may be used to cause a machine, such as, for example, a processor (not shown) to perform the processes 300 and 400. A machine-readable medium includes any mechanism that may be adapted to store and/or transmit information in a form accessible by a machine (e.g., a computer, network device, personal digital assistant, manufacturing tool, any device with a set of one or more processors, etc.). For example, a machine-readable medium includes recordable and non-recordable media (e.g., read only (ROM), random access (RAM), magnetic disk storage media, optical storage media, flash devices, etc.), such as electrical, optical, acoustic, or other form of propagated signals (e.g., carrier waves, infrared signals, digital signals, etc.).

In the above description, numerous specific details, such as, for example, particular processes, materials, devices, and so forth, are presented to provide a thorough understanding of embodiments of the invention. One skilled in the relevant art will recognize, however, that the embodiments of the present invention may be practiced without one or more of the specific details, or with other methods, components, etc. In other instances, structures or operations are not shown or described in detail to avoid obscuring the understanding of this description.

Reference throughout this specification to “one embodiment” or “an embodiment” means that a particular feature, structure, process, block, or characteristic described in connection with an embodiment is included in at least one embodiment of the present invention. Thus, the appearance of the phrases “in one embodiment” or “in an embodiment” in various places throughout this specification does not necessarily mean that the phrases all refer to the same embodiment. The particular features, structures, or characteristics may be combined in any suitable manner in one or more embodiments.

The terms used in the following claims should not be construed to limit embodiments of the invention to the specific embodiments disclosed in the specification and the claims. Rather, the scope of embodiments of the invention is to be determined entirely by the following claims, which are to be construed in accordance with established doctrines of claim interpretation.

What is claimed is:

1. An apparatus, comprising:
an integrated circuit having:
a power plane to supply a predetermined operating voltage in the integrated circuit less than or equal to a reference voltage;
a comparator to compare the voltage supplied by the power plane to the reference voltage and to output a first value if the voltage supplied by the power plane is greater than the reference voltage;
a transistor; and
a fuse, wherein if the output of the comparator is the first value, then the transistor is to turn on and the fuse is to burn open.

2. The apparatus of claim 1, wherein the comparator further comprises a sense input to sense the voltage supplied by the power plane.

3. The apparatus of claim 1, further comprising a test access port (TAP) coupled to read the fuse.

4. The apparatus of claim 2, further comprising a sense amplifier coupled between the power plane and the sense input of the comparator.

5. The apparatus of claim 2, wherein the comparator further comprises a reference input to receive the reference voltage.

6. The apparatus of claim 2, further comprising a reference voltage source coupled to the reference input.

7. The apparatus of claim 1, wherein an output of the comparator is coupled to a gate of the transistor and wherein a drain of the transistor is coupled to the fuse.

8. The apparatus of claim 1, wherein the comparator is further to output a second value if the voltage supplied by the power plane is less than or equal to the reference voltage.

9. The apparatus of claim 8, wherein if the output of the comparator is the second value, the transistor is to remain off and the fuse is to remain intact.

10. The apparatus of claim 1, further comprising:
a second comparator;
circuitry to enable the second comparator, the second comparator to compare the voltage supplied by the power plane to the reference voltage and to output second value if the voltage supplied by the power plane is greater than the reference voltage;
a second transistor; and
a second fuse, wherein if the output of the second comparator is the second value, then the second transistor is to turn on and the second fuse is to burn open.

11. A method, comprising:
comparing a voltage from a power plane with a reference voltage, wherein the voltage from the power plane is an operating voltage for an integrated circuit; and
if the voltage from the power plane exceeds the reference voltage by a predetermined amount, then:
turning on a transistor in the integrated circuit; and
blowing a fuse in the integrated circuit using current from the transistor.

12. The method of claim 11, further comprising reading a value of the fuse.

13. The method of claim 11, further comprising setting the reference voltage at a value substantially equal to 1.4 of the operating voltage for the integrated circuit.

14. A system, comprising:
an integrated circuit having a power plane to supply a predetermined operating voltage in the integrated circuit less than or equal to a reference voltage, a comparator to compare the voltage supplied by the power plane to the reference voltage and to output a first value if the voltage supplied by the power plane is greater than the reference voltage, a transistor, and a fuse, wherein if the output of the comparator is the first value, then the transistor is to turn on and the fuse is to burn open; and
a graphics controller coupled to the integrated circuit.

15. The system of claim 14, further comprising a second set of fuses to enable activation of the comparator.

16. The system of claim 14, wherein the first fuse has one end coupled to a drain of the transistor and a second end coupled to a second power plane.
